(19) United States
(12) Patent Application Publication
(10) Pub. No.: US 2013/0155715 A1
(43) Pub. Date: Jun. 20, 2013

(54) OPTOELECTRONIC FOOD DECORATION AND PACKAGING

(71) Applicants: Samuel Kim, Austin, TX (US); Lucia Kim, Austin, TX (US)

(72) Inventors: Samuel Kim, Austin, TX (US); Lucia Kim, Austin, TX (US)

(73) Assignee: Samuel Kim, Austin, TX (US)

(21) Appl. No.: 13/527,585

(22) Filed: Jun. 19, 2012

Related U.S. Application Data
(60) Provisional application No. 61/500,381, filed on Jun. 23, 2011.

(51) Int. Cl. F21L 4/00; G02B 6/04; F21L 4/02; G02B 6/10

(52) U.S. Cl. CPC F21L 4/00; G02B 6/10; G02B 6/04; F21L 4/02
USPC 362/553; 362/554; 362/190; 362/184

(57) ABSTRACT

Described herein are devices and structures used for decorating food, and food packaging, using a single light source to provide multiple points of light on a panel or panels of the device. The devices may include a structure such as a stand placing the decorative device on a food item, such as a cake. In certain implementations, the structure is part of food package that contains the food product

### RELATED APPLICATION

This application claims the benefit of priority of U.S. Provisional Patent Application Ser. No. 61/500,381 filed Jun. 23, 2011.

### BACKGROUND

The use of electronics and light emitting diodes or LEDs as well as other light sources, has started to emerge in consumer products such as greeting cards, key chains, pens, and so on. Even in food products, the idea of using LEDs and other light sources have been implemented. Many such configurations use discrete light emitting components for each point of light. Typically, light sources, such as, but not limited to LEDs, are used as individual discrete light sources. This is may become costly, because for each point where light is desired, an LED component may have to be placed in that location and may also be supported by any necessary supporting driver chip/electronics. For larger arrays of lights, this becomes complex, difficult, and expensive, especially when a goal is to provide for a mass produced product, such as a decorative food product decoration, packaging or other related item.

### BRIEF DESCRIPTION OF THE DRAWINGS

FIG. 1 illustrates an example device implementing an LED with multiple points of lights.

FIG. 2 illustrates an example device showing front and back panels sandwiching electronics and optical fibers.

FIG. 3 illustrates an example device showing a front panel and optical fibers are attached to the front of the front panel and are threaded through it and gathered together and coupled to a light source.

FIG. 4 illustrates an example device with internal optoelectonic components.

FIG. 5 illustrates an example optoelectonic module.

FIG. 6 illustrates an example popup style decoration.

FIG. 7 illustrates an example food product package with optoelectronics lighting, sound, sensing, and actuation.

FIG. 8 illustrates an example food product package with optoelectronics lighting, sound, sensing, and actuation.

FIG. 9 illustrates an example food product decoration with optoelectronics lighting, sound, sensing, and actuation.

FIG. 10 illustrates an example lay down style tray with optoelectronics lighting, sound, sensing, and actuation.

FIG. 11 illustrates an example stand up type decoration with optoelectronics lighting, sound, sensing, and actuation.

FIG. 12 illustrates different examples of standing decorations on food products and packaging with optoelectronics lighting, sound, sensing, and actuation.

FIG. 13 illustrates an example kick stand decoration with optoelectronics lighting, sound, sensing, and actuation.

FIG. 14 illustrates an example structure with a three dimension decoration with optoelectronics lighting, sound, sensing, and actuation.

FIG. 15 illustrates an example LED light multiplexed or spread to many different points of light using a bundle of optical fibers.

FIG. 16 illustrates an example planar waveguide.

FIG. 17 illustrates an example structure to affix optical fibers to a surface by creating a bulbous feature that makes it too large to fit back through a hole.

FIG. 18 illustrates an example structures to affix optical fibers to a surface.

The following Detailed Description is provided with reference to the accompanying figures. In the figures, the left-most digit(s) of a reference number usually identifies the figure in which the reference number first appears. The use of the same reference numbers in different figures indicates similar or identical items.

### DETAILED DESCRIPTION

Described herein are implementations of an optoelectronic food product decoration or packaging (such as but not limited to cakes, food trays, food presentations, and so on) that uses an apparatus for channeling light, such as an array of optical fibers, or other type of optical waveguide array, affixed to a surface that channel light from a light source (e.g., LEDs, organic light emitting diodes or OLEDs, polymer or polymeric, light emitting diodes or PLEDs, electroluminescent or EL lights, incandescent, fluorescent, lasers, etc.) out to the tips of the optical fibers, where resulting in visible light. The apparatus for channeling light enables the spreading (or multiplexing) of one light source to many points of light. This may include several advantages, for example, lower cost to manufacture and operate compared to using active light emitting components at each location where a point of light is desired, less electricity consumed, resulting in a longer operating time of a power source or a battery. Furthermore, such an optoelectronic food product decoration or packaging may be easier and more cost effective to manufacture, particularly in large quantities.

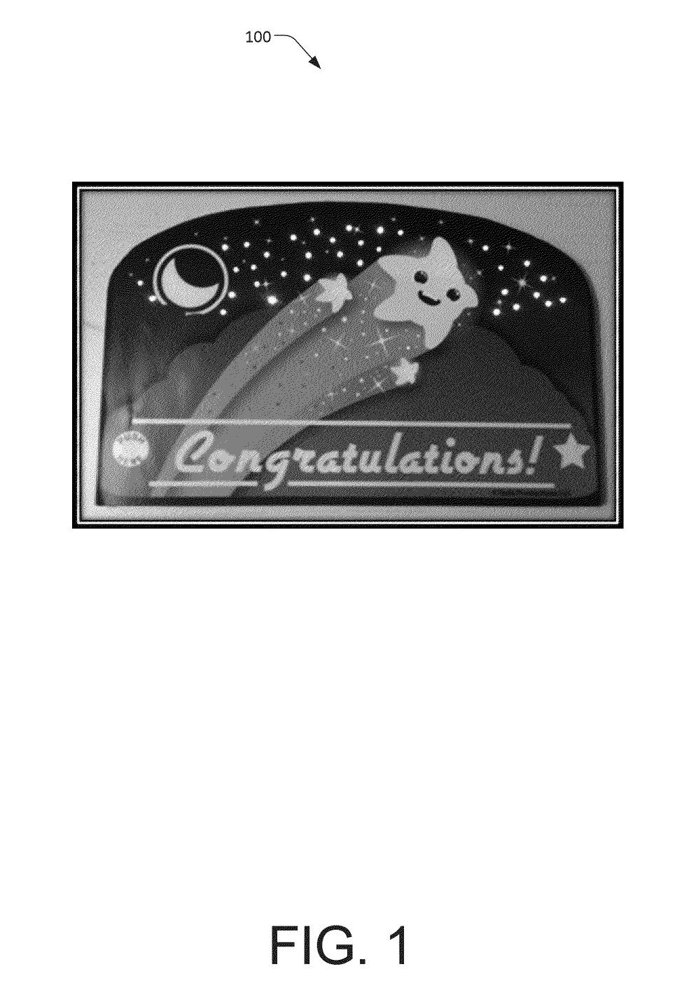

FIG. 1 shows a device 100 using optical fibers using an LED as a light source. Multiple or many points of light are visible to the viewer; however, only one LED or light source may be used to light up all the points shown in FIG. 1. In certain embodiments, more than one set of LEDs and optical fiber arrays can be used to get different points to light up and/or at different times. Furthermore, different colors can either be achieved through the use of color filters or using light sources that emit different colors. Multiple light sources and fiber optic arrays can be used together to get desired colors and timing effects, such as flashing and animation, from the array of point of light visible to the viewer.

The optoelectronic food product decoration or packaging can also incorporate combinations of other functionalities such as: 1) sound and music recording/playback, 2) sensing the environment for example motion, temperature, vibration, light, and so on, and 3) actuation or physical movement by using components such as motors, piezo actuators, solenoids, and so on.

The structures and methods described herein may be used for food product and packaging decorations. For example, the structures and methods may be used to decorate cakes and cupcakes for various occasions such as birthdays, graduations, weddings, and other special events. By incorporating many points of blinking lights with music (or other sound recordings), and potentially other functionalities (such as sensing and mechanical actuation), a decoration can be created that adds to the ambience of the event. The structures and methods may be used for food trays like vegetable platters, appetizers, and so on for parties and other events. The structures and methods can also be incorporated into the packaging of food and other products to make the product stand out on the store shelves or to relay an interactive message, and so on.

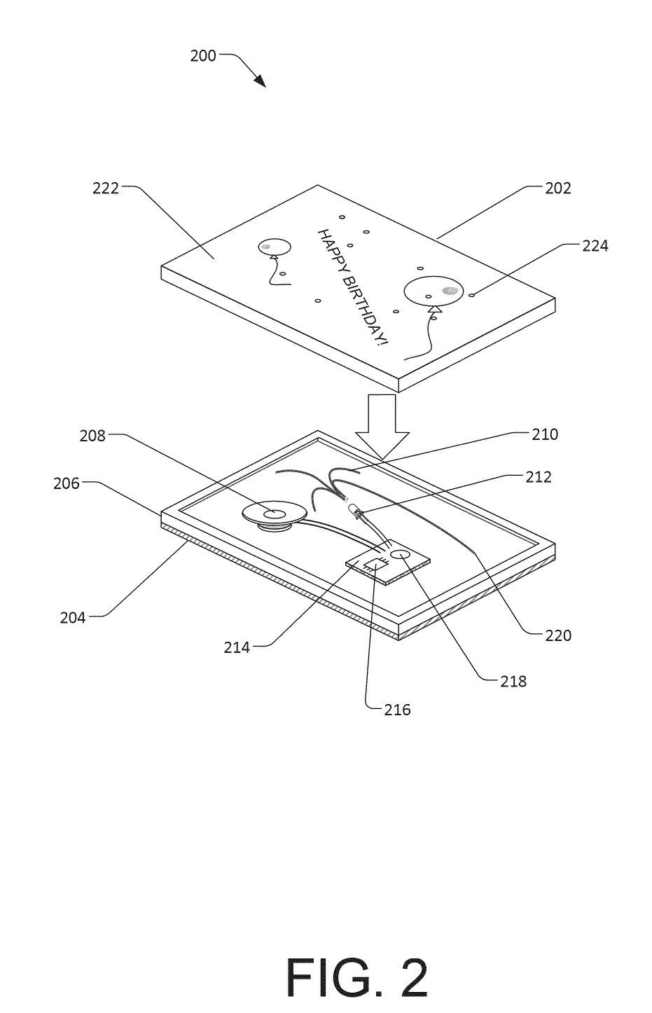

FIG. 2 shows an example device 200 showing front 202 and back 204 panels sandwiching electronics and optical fibers. In this embodiment, the entire electronic assembly is sandwiched between two pieces of a material such as (but not limited to) paper, cardboard, foam board/core, EVA, wood, metals and their alloys, plastics, composites, and others of various sizes depending on the desired design. Front panel 202 and back panel 204 are considered as surfaces of the device 200.

There may be a spacer 206 that separates the front panel and back panel, creating space for the electronics, such as speakers 208, optical fiber bundle 210, a light source (e.g., LED) 212, printed circuit board (PCB) 214, integrated circuit/processor(s) 216 and battery 218. Battery 218 may be any power source.

A tip 220 of the optical fiber 210 allows light to shine. The spacer 204 thickness should be large enough to allow for all the electronics to fit inside. The spacer material can be the same types of materials mentioned for the panels. The front/back panels can be made to be slightly larger than the final foot print such that the extra material can be folded down/up to cover up the spacer materials and inside electronics for a more finished look.

In certain implementations, the front panel 202 may incorporate two dimensional decorative features such, as but no limited to, painted, drawn, stamped, printed, and other types of graphics. The front panel 202 may also incorporate three dimensional decorative features such as cutouts, sculptures, figurines, toys, ribbons, textiles, and so on. A hole(s) or clear areas 224 may be provided to allow light to shine through the front panel 202.

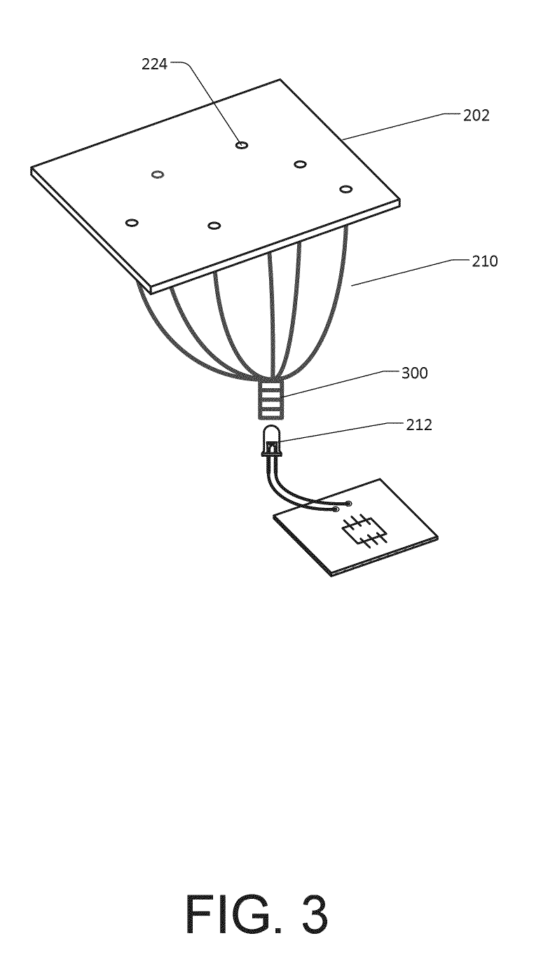

FIG. 2 further shows the optical fibers 210 detached from the front panel 202 to make it easier to see the exploded view, but when fully assembled, the tips of the fibers will be fixed to small openings 224 just large enough to fit the fibers through in the front panel and will be gathered on the other side and fixed together using (but not limited to) tape, glue, rubber bands, and so on, as shown in FIG. 3.

FIG. 3 shows how the optical fibers are attached to the front of the front panel and are threaded through it and gathered (optical gathered) 300 together and coupled to a light source 212. The front panel 202 may have graphics printed on it or other materials can be added to the front panel as desired (such as cardboard cut outs, stickers, glitter, confetti, figurines, toys, etc.) depending on the design of the decoration. The lights showing on the front panel can be coordinated together with a sound module or other modules for the desired effect.

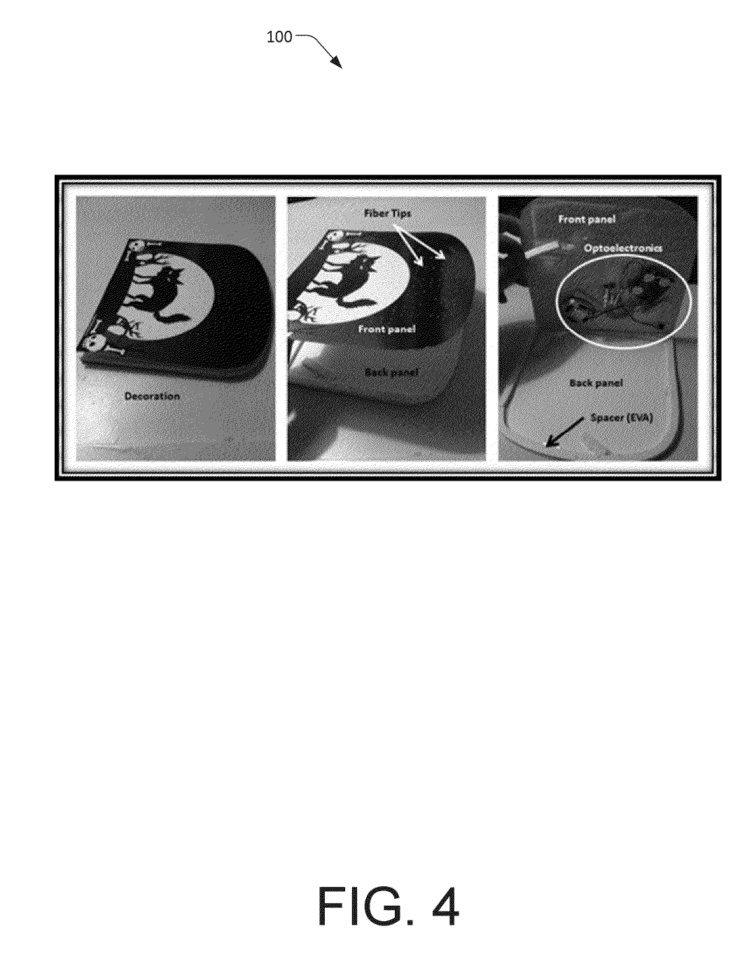

FIG. 4 shows an example device 100 with a graphic on the front panel. The tips of the fibers are affixed to the front panel. This can be seen most easily in the center photo when the front panel is held at an angle. Inside the decoration, spacers, optoelectronic module, and the fibers are illustrated.

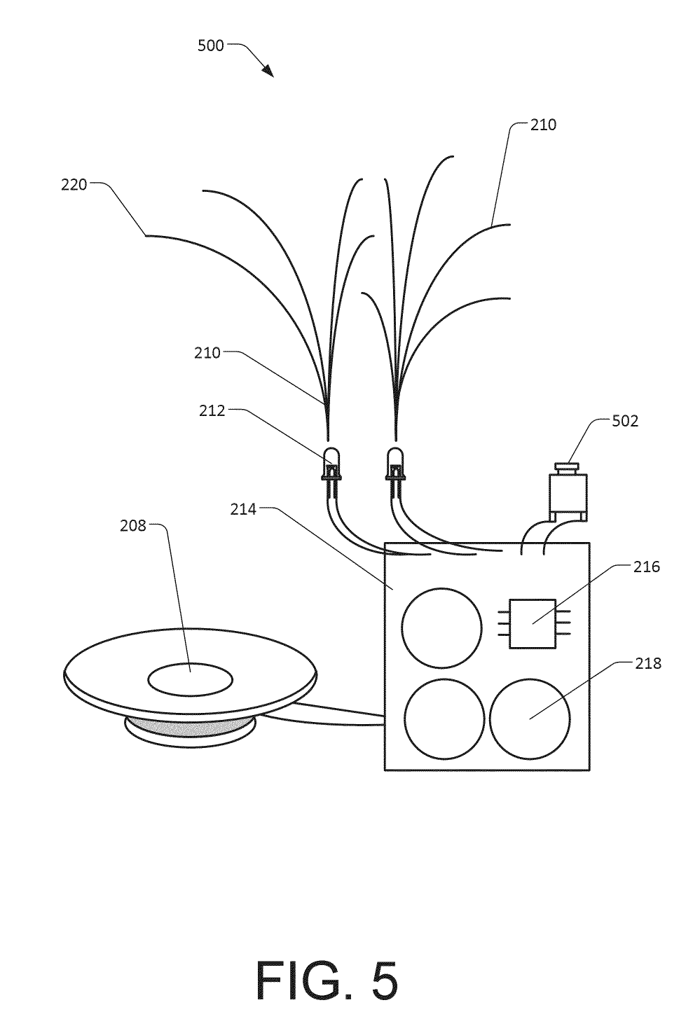

FIG. 5 shows an example optoelectronics module 500. In an implementation, the optoelectronics module 500 may include the printed circuit board (PCB) 214 onto which battery(ies) 218, integrated circuit (IC)/processor 218, and wires are connected. There may be a button 502 which is connected to an input of the IC 218, which activates the module 500 and executes a series of functions programmed onto the IC 218, such as flashing lights, playing music, and so on. The low profile speaker 208 on the lower left plays the music but is thin enough to fit into the flat shaped decoration. In this example, there are two LEDs 212 wired up to the PCB 214 which is turned on and off through the IC 216. The LEDs 212 are coupled to bundles of optical fibers 210 by first taping them together with electrical tape and then covering them with a foil tape to keep the light contained within the coupling as much as possible. Many other ways can be used to couple the LEDs 212 to the bundles of optical fibers 210. For example, a part may be fabricated that mechanically and optically couples the LED and optical fibers together.

The sound function can be used via a module that is capable of playing a sound or music file via small speakers which are incorporated into the decoration. The sound module can also be capable of recording a sound or music file using an input source such as a microphone. A personal message or greeting can be recorded onto the decorative product.

In certain implementations, a sensing functionality can be used via a module or sensor that is capable of sensing input and communicating the state of the external environment via sensors using components such as accelerometers, gyros, oscillators, switches, and so on. For example, a switch pressed by a person can trigger an event, such as flashing the light module, playing a sound file, and/or an actuation (vibration). Or a sensor can detect someone blowing on the decorations and can react (this can be useful for a birthday card where the LED 212 blink and then when someone blows on it, it stops blinking, for example). Or when someone picks up the decoration, it can be activated by a sensor, such as an accelerometer.

An actuation module may be used by incorporating components such as motors, piezos, solenoids, and so on to create desired mechanical effects (such as vibration, movement, and so on).

The optoelectronic assembly 500 may also include other electronic components necessary for the functionality of the modules such as batteries (or other energy storage devices), wires, solder, PCB boards, memory, electronic drivers, and so on. It is also possible for the electronic module to include a means of energy generation or energy harvesting to maintain or sustain longer battery life, for example, by incorporating a photovoltaic cell. The light modules, sound modules, sensing modules, and actuator modules can be synchronized or not, depending on the intended effect. This devices and structures should be safe enough to incorporate with food products, and pass food safety regulations both in terms of the materials used as well as the manufacturing methods used to construct it. Furthermore, the devices and structures should pass testing and other certifications for regulatory requirements such as lead, flammability, toxicity, and so on.

In another embodiment, the front panel 202 may simply serve as a structural element holding the tips of the optical fibers in place. Then a plastic film or sheet can have a graphic printed on it and then laid over the lighting elements. Portions of the printed graphic on the plastic film can be transparent/translucent, to let the light shine through the film the desired amount. One of the advantages of this approach is that the top surface can be smooth, and not have the tips of the optical fibers sticking out of the surface of the decoration.

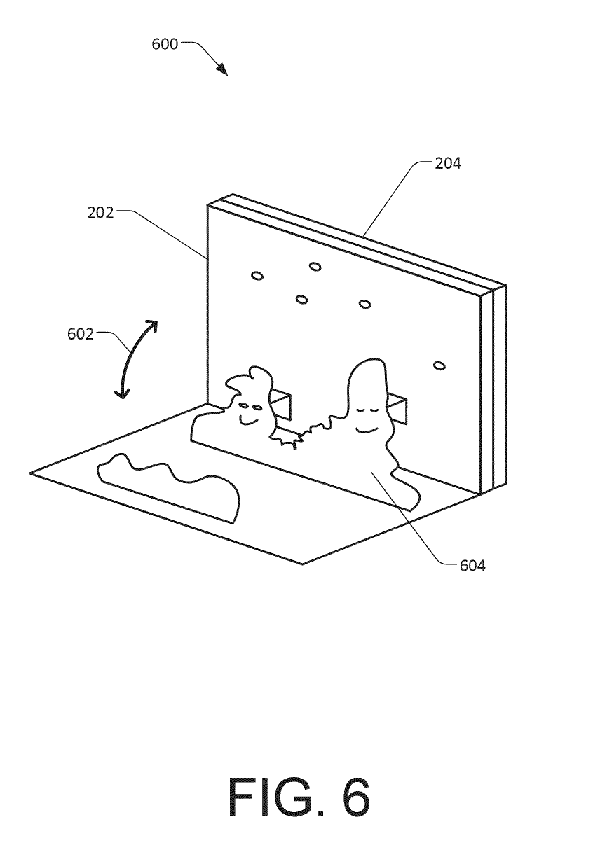

FIG. 6 shows a popup style decoration 600 that may incorporate the described device. In an embodiment, the fiber optics are incorporated with a three dimensional pop-up type display to open and close 602 (similar to a children's pop-up type book) that has fiber optics incorporated with it giving a lighted display 604 that is also three dimensional.

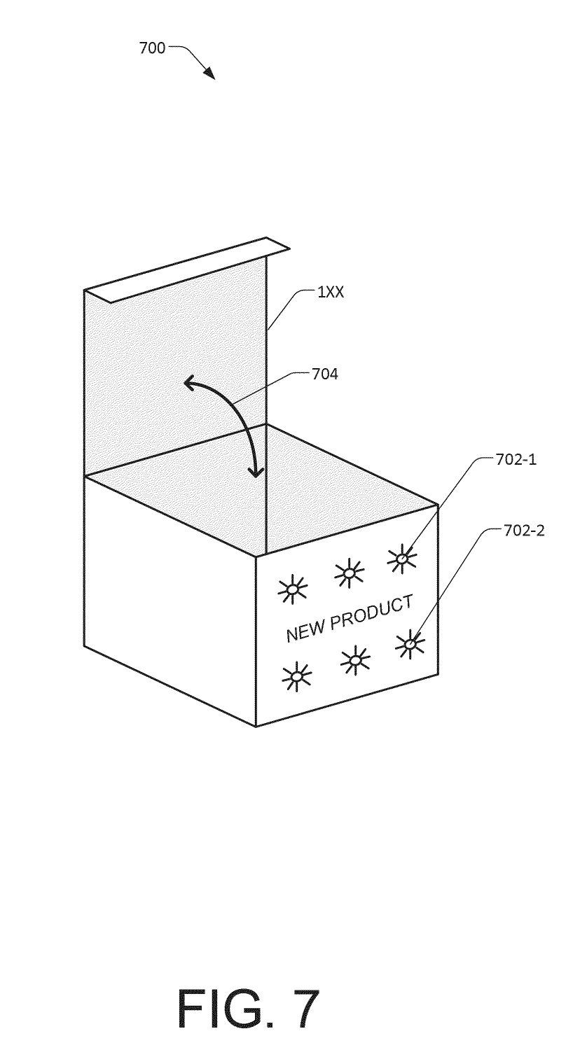

FIG. 7 shows an example product package 700. The product package 700 may include lighting, sound, sensing, and actuation. In an embodiment, the electronic/optical assembly can be used as a part of the box or packaging for a food product having a lid 702 that opens and closes 704. A central light module can channel light through the optical apparatuses (e.g., waveguides) to various parts of the packaging for different lighting effects through lights 702. Other modules can also be added for other desired effects.

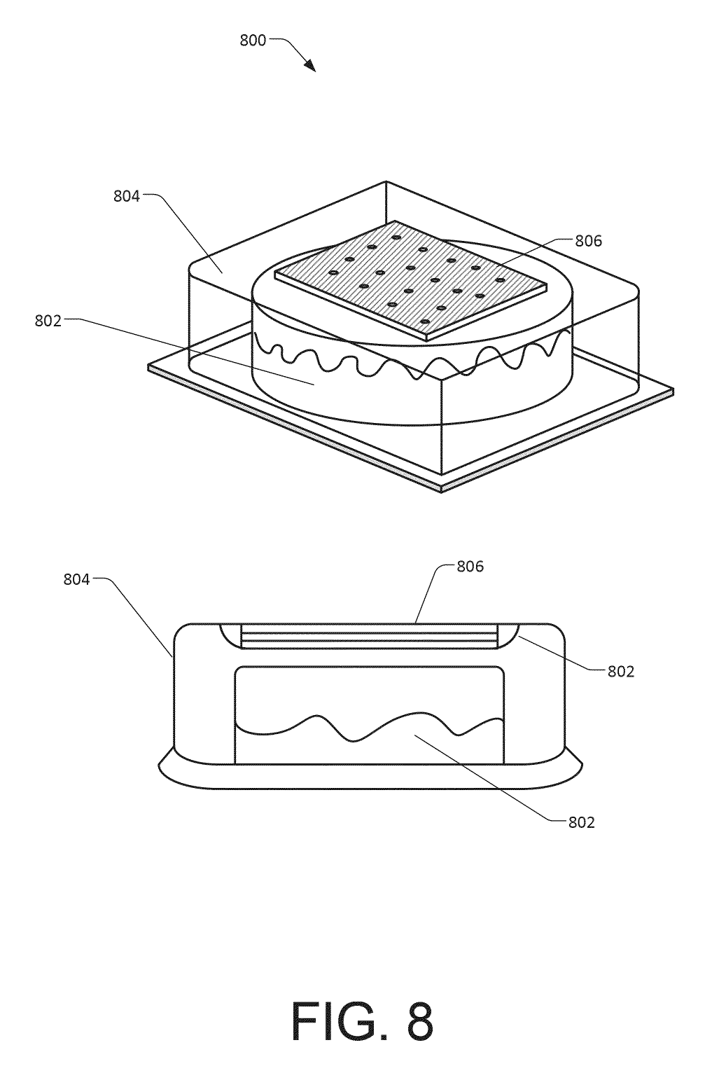

FIG. 8 shows an example product 800 package for cakes. A decoration can also be included into a packaging for cakes also as shown in FIG. 8. An indentation 802 can be made in a cover 804 and the decoration 806 can be placed on top as shown.

In other implementations, the described electronics/optical assembly can be a part of a three dimensional structure such as a toy (like a tiara, a crown, action figure, doll, plush toy, teddy bear, blocks, boxes, etc.) or any other decorative items (such as fake or real flowers, blocks, sculptures, art, wires, etc.). The tips of the array of optical fibers would be anchored to the outer surface of the three dimensional structures.

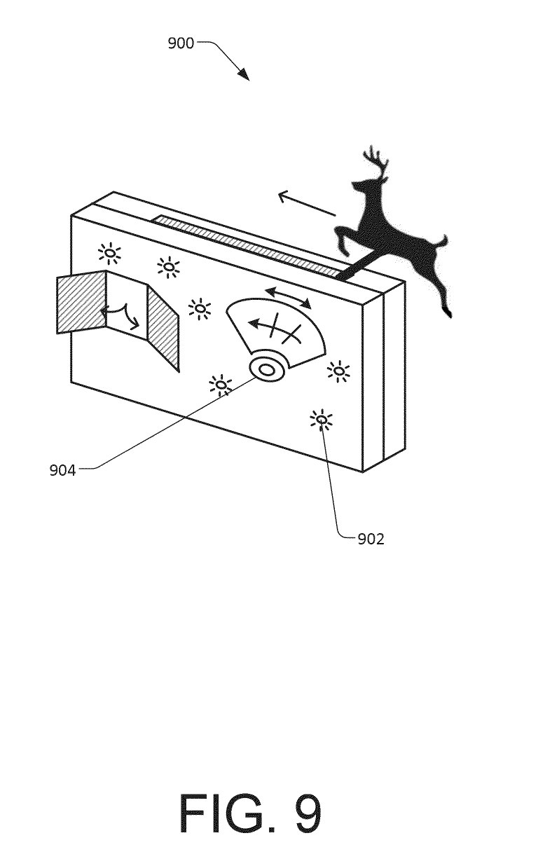

FIG. 9 shows a device with various mechanical actuation and sensing mechanisms. Lights 902 as previously described may be implemented. 904 represents mechanical actuation and sensing mechanisms such as but not limited to motors, springs, solenoids, levers, piezo actuators, etc. The mechanisms and actuators 904 may even be moved through human force input, such as children's books that incorporate interactive elements such as flaps that can open/close or tabs that are pulled that move another element.

The described devices may also make use of a structure that enables the decoration to be displayed in a variety of ways. If it is desired for the decoration to be laid down flat onto a food product (i.e. cake) it needs to be made of food grade material in an approved process, meaning that it is certified safe to be in direct contact with food. If the decoration itself is not made using a process or materials required to be food grade, a food grade barrier can be placed between the food and the decoration.

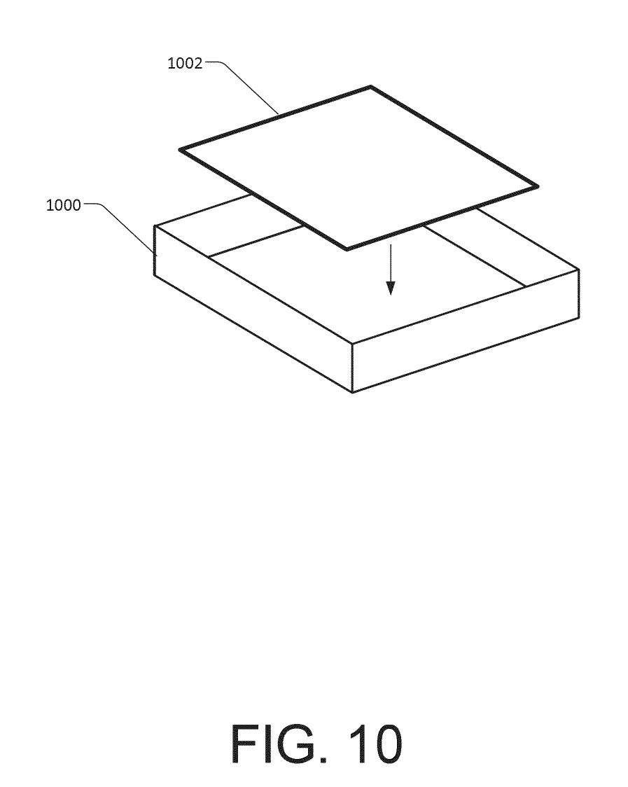

FIG. 10 shows a tray 1000 that can be made of food grade plastics and a decoration 1002 can be placed into the tray. Alternatively a food grade film (such as but not limited to paraffin or wax) can be deposited or glued (such as but not limited to commonly used plastic wrap materials) to the side that comes into contact with the decoration.

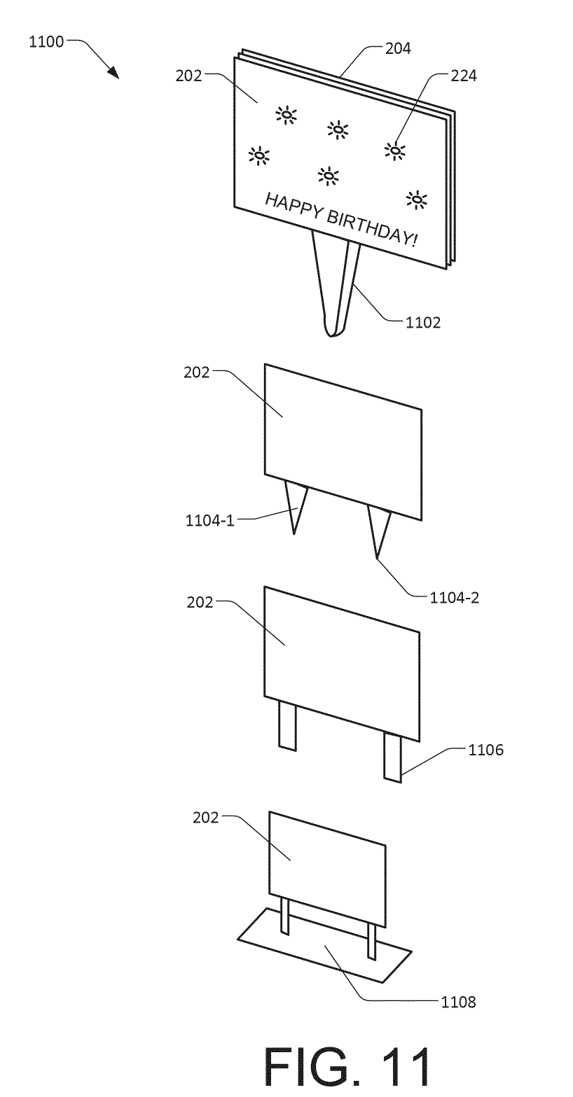

FIG. 11 shows a stand up type decoration 1100 with a stake 1102 that can be inserted into the food product. In certain implementations, the decoration may stand up, so that the decoration sticks out from the food product like a sign post. This structure 1100 can sit on top of the food product or stick into it to allow it to stand upright as shown. The portion (i.e., stake 1102) of the decoration/structure 1100 that touches or sticks into the food product should also be food grade.

The physical structure can be an extension of the same materials used to make the display module itself, or it can be an entirely different material (such as plastic) that is later affixed to the electronics assembly module. FIG. 11 shows options for how the electronics assembly module may include a structure to mount it or incorporate it with the food product or packaging. For example, a single stake type protrusion 1102, or multiple protrusions 1104 may be used to stick the decoration 1100 into a cake or other food product or display or packaging so that it can stand up right for display purposes. The stakes may be of different shape as illustrated by stake 1106. Furthermore, a different support structure 1108 may be implemented in certain embodiments.

It certain implementations, a plastic tray can include the lighted electronics assembly module and can lay flat (or at an angle depending on the angle of the bottom of the tray) inside to protect lighted electronics assembly module from the food or to protect the food from contaminants of the product. In other words, the bottom of the tray can be inclined if the display is to be angled.

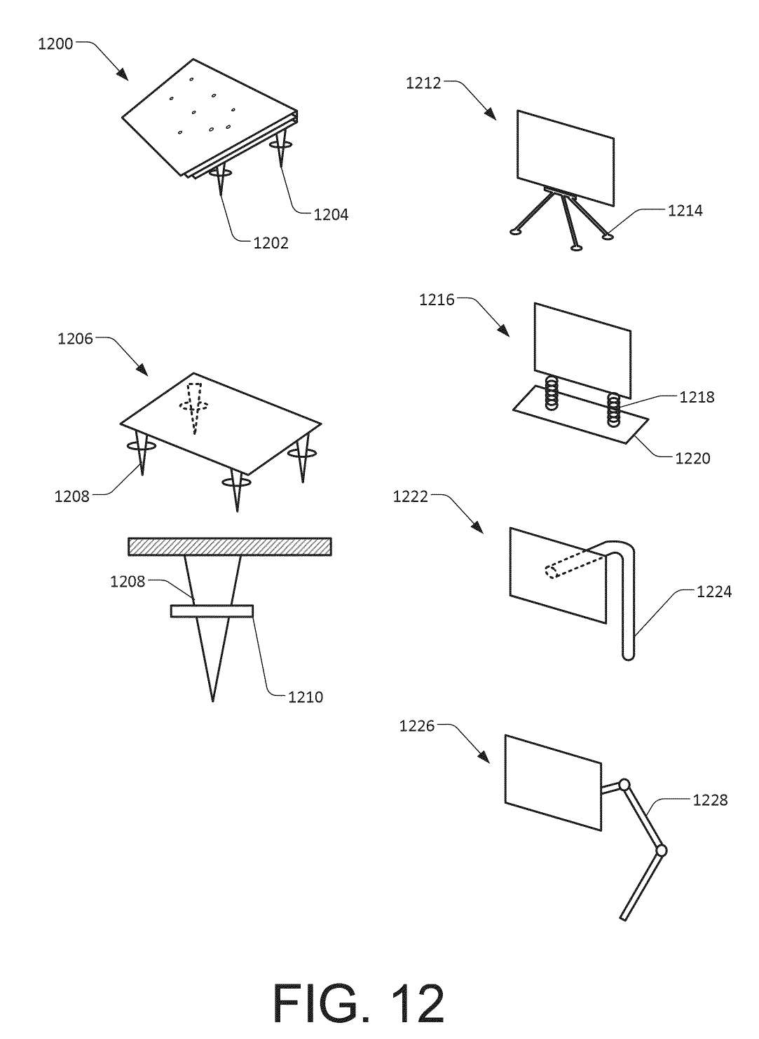

FIG. 12 shows various implementations for a stand or stake. As shown in 1200, the stakes 1202 and 1204 can be of different heights so that the display module can be angled according to the desired effect in the final presentation.

As shown in 1206, stakes 1208 can have a stopper 1210 that limits protrusion into the cake or other food product. The stake or protrusion 1208 can include a flange or stopper 1210 on the protrusion or stake 1208 to prevent the stake 1208 from going in too deep into the food product or to give it a certain stand-off distance from the top of surface of the food product (i.e. cake) to the bottom of the display module.

In implementation 1212, a tripod or multi-legged assembly 1214 can be used to stand the display module on top of the food product. In an implementation 1216, the display module may have springs 1218 and a foot structure 1220. In an implementation 1222, the display module can have a support structure 1224 in the back. In an implementation 1226, the display module can have an articulating structure 1228 allowing the display module to be position at a desired angle.

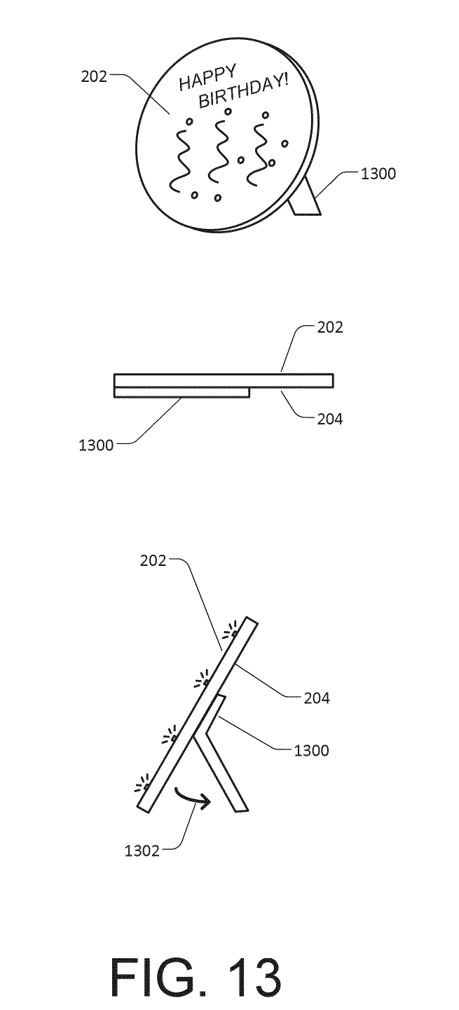

FIG. 13 shows an implementation of a foldable kick stand 1300. The stand can be like a kick stand that folds out 1302 when in use, and folds down when not in use or if it should be used flat.

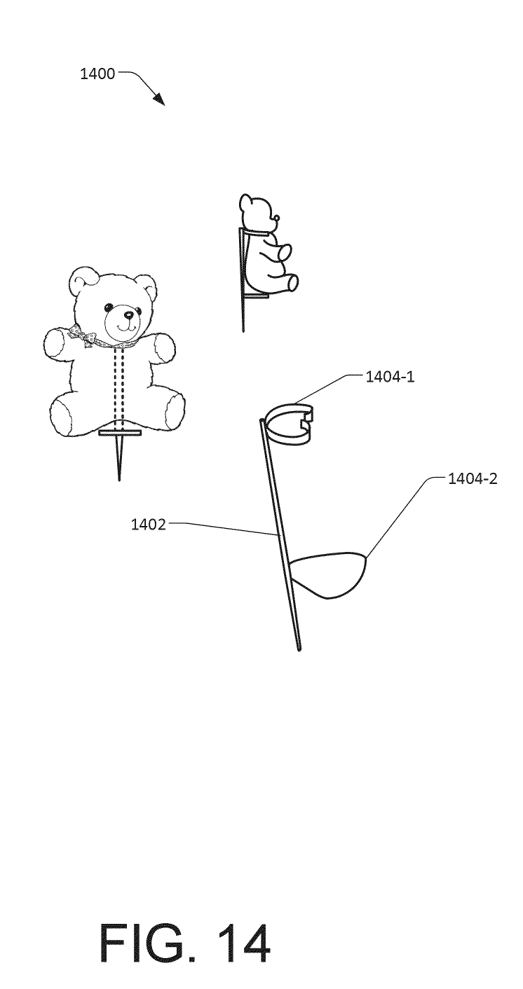

FIG. 14 shows a decorative product in the form of a three dimensional object 1400, such as a stuffed animal, three dimensional toy, plastic figurine, and so on. A stand 1402 may be implemented to clip onto the object, holding the object above the food to preventing the object from getting dirty. The stand 1402 may include one or more clips or mounting apparatuses 1404.

The described devices/products may use LEDs (or other light sources such as LEDs, OLEDs, lasers, electroluminescent lights, and so on) coupled to optical apparatuses such as fiber optics and waveguides (which can be cylindrical fibers, planar, or other) to spread the light of the light source to an array of many more points of light.

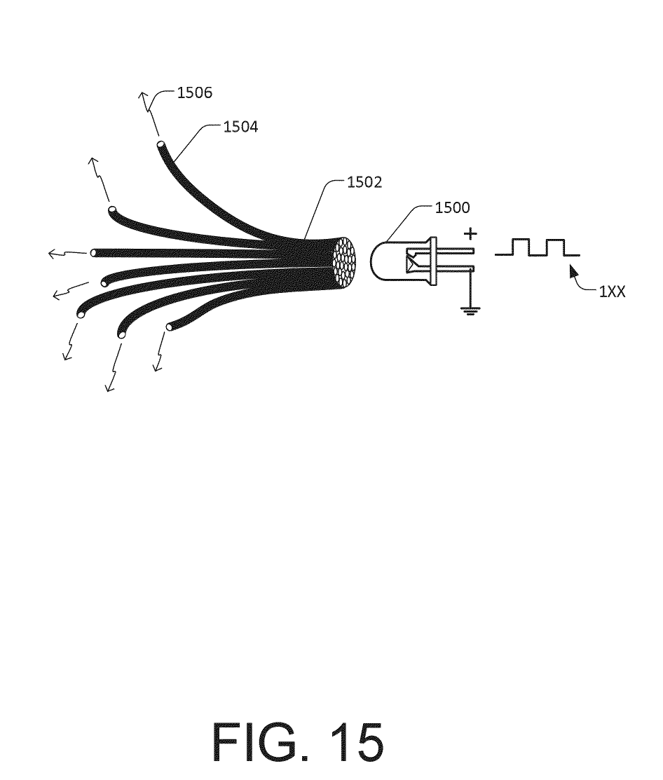

FIG. 15 shows a light from a single LED 1500 channeled using a bundle 1502 optical fibers 1504 to many points of light. In particular, multiplexing/splitting the light by using an array of optical fibers 1504 is implemented. A point of light 1506 is emitted at each end of the optical fibers 1504. This may enable a more attractive display at a lower cost than having to use a light source for each point of light. A signal 1508 may be applied to the LED 1500 to blink on or off. The optical fibers 1504 may be consider an apparatus for channeling light.

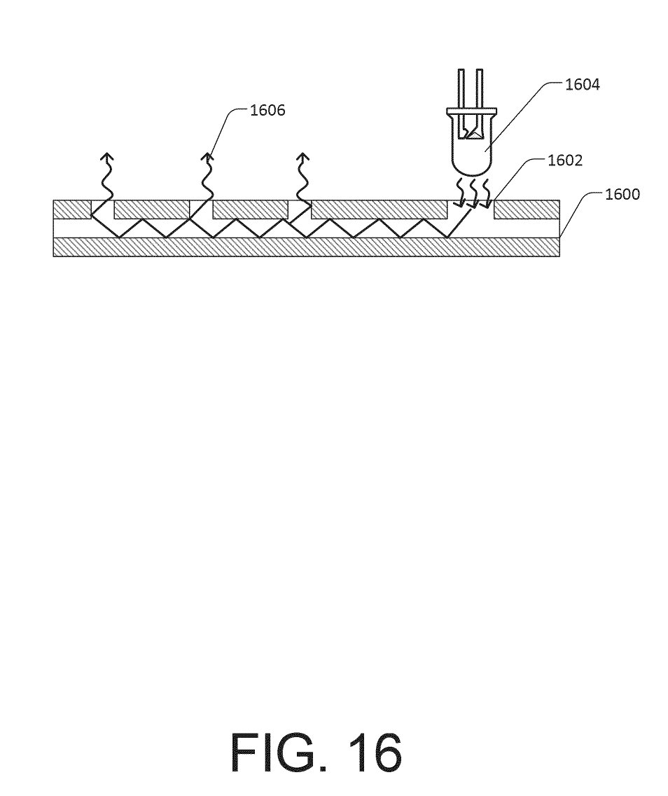

FIG. 16 shows the use of a planar waveguide 1600. The waveguide 1600 (i.e. optical fiber) may be part of the structural material or substrate, so that loose optical fibers do not need to be used. The waveguide 1600 (functioning similarly to optical fibers) can also be integrated directly into the material (such as with plastic molding, etc.) such that individual fibers are not necessary, are embedded into the substrate itself, or are just inherently part of the substrate. The waveguides channel the light 1602 from an LED/light source 1604 to multiple desired locations 1606 from fewer sources. The waveguide 1600 can be planar or three dimensional, depending on the desired look of the final product.

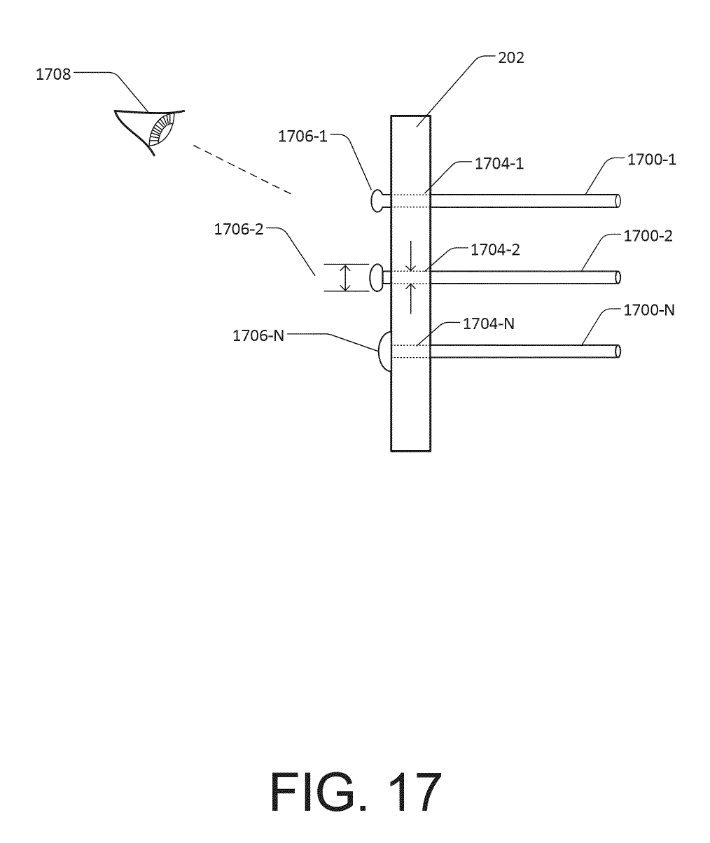

FIG. 17 shows an example structure to affix optical fibers 1700 to a surface, such as front panel 202 by creating a bulbous feature 1702 that is too large to fit back through a hole 1702. A final configuration of the device may provide that an array of optical fibers affixed onto a surface so that the optical fibers are not loose. The tips of the fibers 1706 are larger than the diameter of the fiber (for example having a bulb shaped tip) such that the fiber cannot be pulled through the hole 1704 that is only slightly larger than the diameter of the fiber. The straight end of the fiber is affixed to the other side and light can be shined through the optical fiber to the bulb shaped tip on the surface. In certain implementations, the end 1706 may be melted to stick to the front panel 202.

One possible method of getting the ends 1702 of the optical fibers 7800 to stay in place once attached to a panel 202 in a high volume manufacturing process is described. The panel 202 may be prepared by punching holes 1704 just larger than the diameter of the optical fibers 1700. Then the optical fibers 1700 are threaded through the holes 1704 and gathered into bundles. The end 1702 will be optically coupled to the LED or other light source on the inside of the decoration. The optical fibers 1700 may secured using tape or other adhesive to fix the fibers to the backside of the panel 202.

On the other side of the panel 202, there may be strands of the optical fibers 1700 still sticking out. The ends may be cut off using a number of different methods such as (but not limited to) a flame, blade, scissors, pliers, tweezers, crimping tool, saw, or other tool and/or process which can deform (such as melting or crimping) the tip of the optical fiber, forming an end with a larger diameter than the fiber itself, making it too large to fit back through the front panel 202. Another way to achieve this is to clip the fibers 1700 and then melt the tips using a heat gun. This will deform the tips through heat leaving a bulbous shape that will not pull through the panel 202. Using a melting process can also melt some of the optical fibers 1700 onto the front panel creating a type of adhesive such that once cooled, the fiber is stuck to the panel 202. Basically by melting the optical fiber 1700 (or deforming it another way such as crimping, pressing, rolling, and so on), the optical fiber 1700 may be prevented from going back through, and creates a physical connection to the panel 202. Additionally, a separate object, such as a plastic disc, button head, bead, rivet, and so on, having a larger diameter than the optical fiber, can be attached to the optical fiber so that the fibers can be affixed to the panel in a similar manner.

The optical fibers 1700 may also be pre-made to have a physical feature (like a bump with a larger diameter than the rest of the fiber), or other physical feature that holds the fibers in place. In this approach, the fibers can just be threaded into the holes with the larger diameter end of the fiber facing outwards toward the viewer 1708.

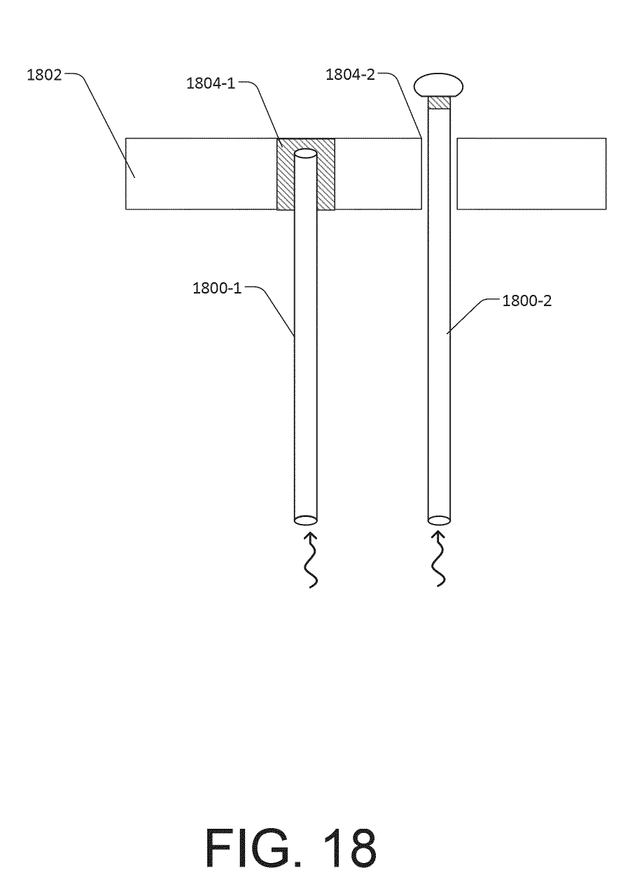

FIG. 18 illustrates an example structures to affix optical fibers 1800 to a surface 1802. Glues, epoxies, adhesives, tapes, putties, and so on may also be used to hold the optical fibers 1800 in place. For example, a small dab of glue or epoxy can be placed into the holes 1804, the fiber tip can be placed in the hole with the epoxy, and when it is cured, the tip of the fiber will be attached to the hole on the front panel.

Once the fibers are fixed to the surface, a large piece of adhesive tape, foam, etc. can be laid over the backside to hold the back part of the fibers in place. In this way, the front and back of the fiber are mechanically fixed to prevent movement of the fiber.

What is claimed is:

1. An optoelectronic food decorative device comprising:
one or more light sources;
apparatus for channeling light from the one or more light sources;
a power source to provide power to the one or more light sources;
a surface wherein ends of the apparatus for channeling light are anchored; and
a structure that places the optoelectronic food decorative device on to a food product or houses the food product.

2. The optoelectronic food decorative device of claim 1, wherein the apparatus for channeling light include multiple optical fibers, or optical waveguides that are part of an array, which multiplexes the single light source to multiple points of light.

3. The optoelectronic food decorative device of claim 1, wherein the one or more light sources are one of a light emitting diode (LED), organic light emitting diodes (OLED), polymer/polymeric light emitting diodes (PLED), electroluminescent (EL) light, incandescent light, fluorescent light, or laser light.

4. The optoelectronic food decorative device of claim 1, wherein the surface incorporates a three dimensional feature.

5. The optoelectronic food decorative device of claim 1, wherein the structure incorporates a stand or stake that holds the optoelectronic food decorative device on to the food product.

6. The optoelectronic food decorative device of claim 1, wherein the structure is a package that houses the optoelectronic food decorative device and contains the food product.

7. The optoelectronic food decorative device of claim 1 further including speakers to play sound/music, sensors to detect motion, microphone to record sounds, and actuation mechanisms.

8. A food product decoration comprising:
an optolectronic module that comprises:
a light source;
an integrated circuit that controls the light source;
a battery that powers the light source;
one of a bundle of optical fibers or a wave guide that receives light from the light source;
a surface that receives ends of the optical fibers or openings of the waveguide to display light at multiple locations of the panel; and
a structure that places the optoelectronic food decorative device on to a food product or houses the food product.

9. The food product decoration of claim 8 wherein the light source is a single light source.

10. The food product decoration of claim 8 wherein the light source is one of a light emitting diode (LED), organic light emitting diodes (OLED), polymer/polymeric light emitting diodes (PLED), electroluminescent (EL) light, incandescent light, fluorescent light, or laser light.

11. The food product decoration of claim 8 wherein the integrated circuit includes one or more processors to control the display of light at the multiple locations of the panel.

12. The food product decoration of claim 8 wherein the structure is food packaging, such as a box, and the decoration is integrated into the food packaging.

13. The food product decoration of claim 8 wherein the structure incorporates a stand that allows the food product decoration to be placed on a food product.

14. The food product decoration of claim 13 wherein the stand is one of a single stake, tripod, kick stand, articulating support.

15. The food product decoration of claim 8, wherein the structure is a food tray.

16. A food product decoration comprising:
a front panel;
multiple points of light that are received at the front panel;
a lighting apparatus to provide the multiple points;
a single light source that provides light to the lighting apparatus; and
a structure to support the food product decoration.

17. The food product decoration of claim 16 wherein the lighting apparatus is a waveguide that is integrated into the front panel.

18. The food product decoration of claim 16 wherein the structure is a food container.

19. The food product decoration of claim 16 wherein the structure incorporates a stand that is placed on to a food product.

20. The food product decoration of claim 16 wherein the structure is an adjustable stand that allows the front panel to be positioned as desired by a user.
